(19) United States
(12) Patent Application Publication
(10) Pub. No.: US 2006/0044796 A1
(43) Pub. Date: Mar. 2, 2006

(54) Mixing light board

(75) Inventors: Bily Wang, Hsin Chu City (TW); Jonnie Chuang, Chiao City (TW); John Lin, Chia I Hsien (TW)

Correspondence Address: TROXELL LAW OFFICE PLLC;SUITE 1404, 5205 LEESBURG PIKE, FALLS CHURCH, VA, 22041, US

(73) Assignee: Harvatek Corporation

(21) Appl. No.: 10/923,687

(22) Filed: Aug. 24, 2004

(51) Int. Cl. F21S 13/14; F21V 21/00

(52) U.S. Cl. 362/249; 362/252; 362/800

(57) ABSTRACT

A mixing light board which shows specific pattern is described. The present invention have some advantages, including simple construction, easy production, thinness and cheapness. The mixing light board has a body with a front surface and a back surface. A plurality of conducting material is set on the front surface of the body. A plurality of LEDs is mounted by SMT on the front surface of the body, and the plurality of LEDs is arranged to form a specific pattern. The mixing light board can be made to fit demands.

### BACKGROUND OF THE INVENTION

1. Field of the Invention

The present invention relates to a mixing light board, especially to a signboard for advertisement or exhibition, in which the mixing light board can show a specific pattern and can be in any shape.

2. Description of Prior Art

A signboard for advertisement or exhibition can be made with a neon lamp and an LED matrix. Most advertisement boards shows patterns by bending the neon lamp, but this method is inconvenient, expensive, and invariable in the display thereof.

The LED matrix signboard is made by placing the LED in a matrix and controlling the signboard by a controller. The LED matrix signboard can show different patterns and the display thereof can be highly varied, but it is too complex to manufacture and the signboard is very thick. The LED matrix signboard also is extremely expensive. An LED matrix signboard that shows just a specific pattern is prohibitively expensive.

### SUMMARY OF THE INVENTION

It is the object of the present invention to provide a mixing light board, which shows specific pattern. The present invention has some advantages, including simple construction, easy production, and the resultant board is thin and cheap. The present invention can be constructed depending on the user's demand.

The present invention provides a mixing light board, which comprises a body with a front and a back surface, a plurality of conducting material set on the front surface of the body, and a plurality of LEDs. The LEDs are set on the front surface of the body and in a specific pattern by surface mount technology (SMT).

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself, however, may be best understood by reference to the following detailed description of the invention, which describes certain exemplary embodiments of the invention, taken in conjunction with the accompanying drawings, in which:

FIG. 1 shows a front diagram of the present invention;

FIG. 1A shows a local diagram of the present invention;

FIG. 2 shows a back side diagram of the present invention;

FIG. 3 shows a front diagram of one embodiment of the present invention; and

FIG. 4 shows a front diagram of another embodiment of the present invention.

### DETAIL DESCRIPTION OF THE INVENTION

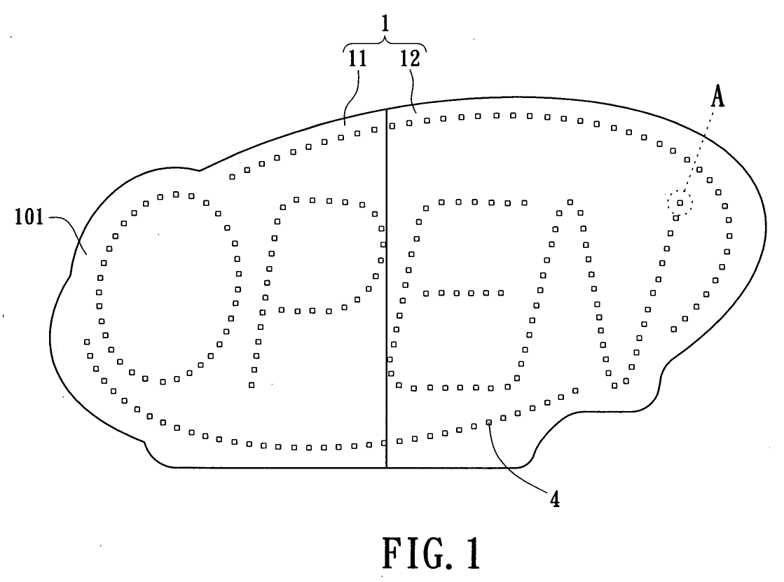

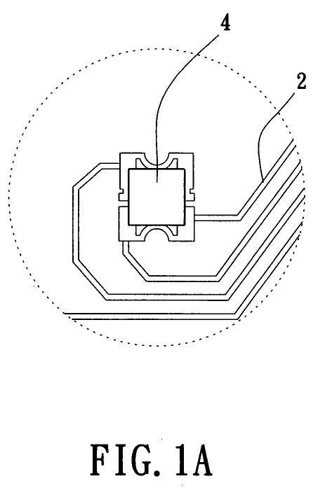

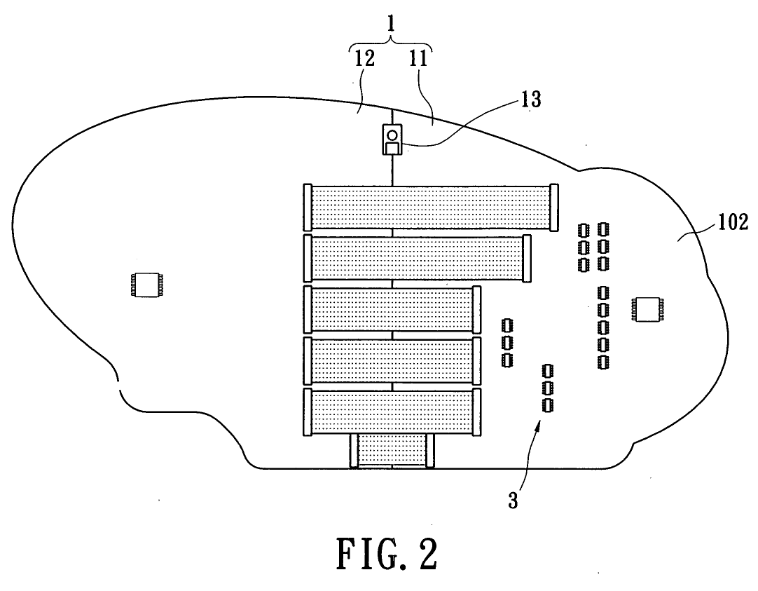

Reference is made to FIG. 1, FIG. 1A and FIG. 2. The present invention is a mixing light board showing specific patterns, which mixing light board comprises a body 1, a plurality of conducting materials 2, a plurality of controllers 3 and a plurality of LEDs 4. LEDs 4 are mounted by SMT (surface mounting technology).

The body 1 comprises a front surface 101 and a back surface 102. The conducting materials 2 are set on the front surface 101. In one preferred embodiment, the body 1 can be a circuit board. Therefore, the conducting materials 2 set on the front surface 101 are the circuit wiring of the circuit board. For example, the conducting materials 2 can be printed on the front surface 101, and the front surface cant be a printed circuit board (PCB). It will be understood that the body 1 is not limited by the description here.

In the second preferred embodiment, a plurality of small boards constitute the body 1, and the small boards have connecting component 13 on the back surface 102 to fix the small boards. As in FIG. 1, the preferred embodiment comprises a first body 11 and a second body 12.

The plurality of LEDs 4 is electrically connected to the conducting materials 2 by applying surface mounting technology (SMT). In one preferred embodiment, the plurality of LEDs 4 can show different color of light. In another preferred embodiment, the plurality of LEDs 4 can be controlled by a controller. Therefore, the plurality of LEDs 4 can radiate, turn off, twinkle, and change colors regularly or irregularly.

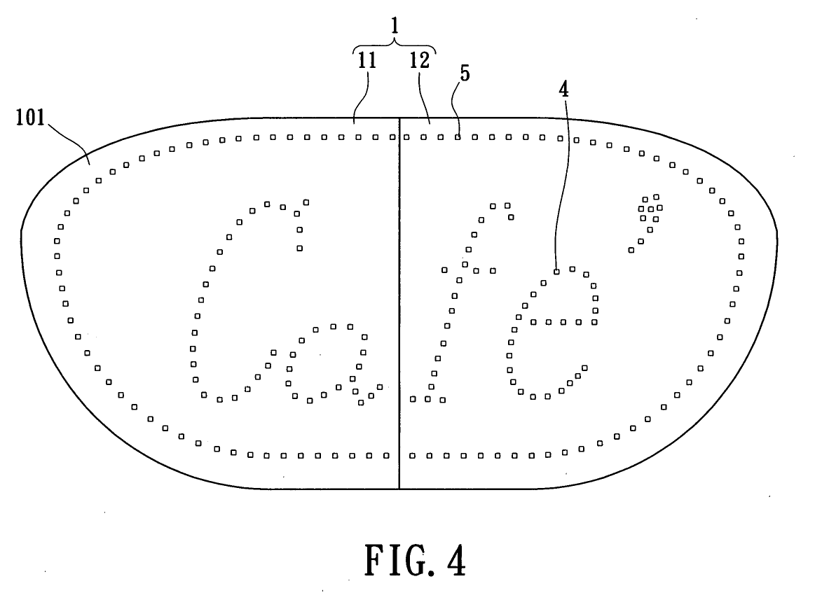

The numbers and the positions of the LEDs 4 are not limited. Depending on demand, the plurality of LEDs 4 can be arranged to show a meaningful word, such as ‘OPEN’ in FIG. 1, and also be arranged to form another word, ‘Cafe’, as in FIG. 4.

The controllers 3 are set on the back surface 102; the controllers 3 electrically connect the conducting materials 2 and the plurality of LEDs 4 so as to control the LEDs 4 to change colors or shut down. The plurality of LEDs 4 each can radiate different colors of light so as to provide a light mixing effect.

Reference is made to FIG. 1; the components mentioned above constitute the mixing light board of the present invention. One can apply the present invention to make a pattern. The preferred embodiment is to use the controllers 3 to make the figure twinkle or have different light mixing effects.

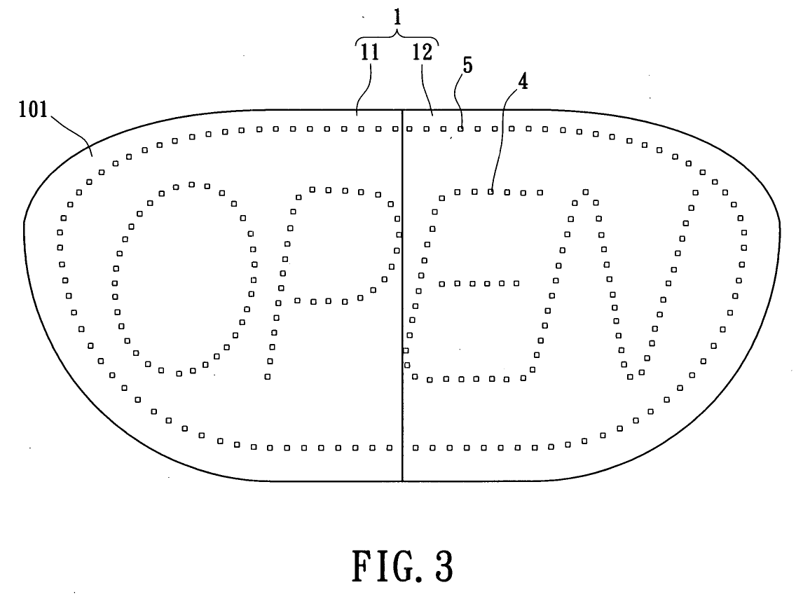

In another embodiment of the present invention, illustrated in FIG. 3, the front surface 101 of the body 1 further comprises a plurality of secondary conducting materials 2. The secondary conducting materials 2 can be contrast with FIG. 1A. A plurality of secondary LEDs 5 is also set on the secondary conducting materials 2 to form another pattern.

As shown in FIG. 3, the pattern made by the plurality of secondary LEDs 5 is the circle set on the front surface 101. The secondary conducting materials 2 and the plurality of secondary LEDs 5 all electrically connect to the controllers 3, and the controllers 3 controls the LEDs 5 to have different colors of light or operation states.

One preferred embodiment is that the plurality of secondary LEDs 5 forms a circle pattern, the LEDs 5 of the circle pattern can be turned on and off in a specific sequence.

The conducting materials 2 of the present invention also can be set on the back surface 102 of the body 1. In this way, the function of the present invention still remains.

The present invention mentioned above has a simple construction, is easily produces and is thin and cheap.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claim is:

1. A mixing light board which shows specific patterns, comprising:
a body, including a front surface and a back surface;
a plurality of conducting materials set on one of the front surface and the back surface of the body; and
a plurality of LEDs connected by SMT (surface mount technology) and set on the front surface of the body;
wherein the plurality of LEDs electrically connects to the conducting materials on the front surface, and a specific pattern is constructed by the plurality of LEDs.

2. The mixing light board as in claim 1, further comprising a plurality of controllers set on the back surface, wherein the controllers electrically connect the conducting material and the plurality of LEDs, and the controllers control the plurality of LEDs.

3. The mixing light board as in claim 2, wherein the front surface of the body also comprises a plurality of secondary conducting material, a plurality of secondary LEDs mounted by SMT electrically connect to the secondary conducting material to form a secondary specific pattern, the secondary conducting material and the secondary plurality of LEDs are connected to the controllers, and the controllers controls the plurality of LEDs.

4. The mixing light board as in claim 1, the body further comprising a plurality of small boards, and the small boards constitute the body.

5. The mixing light board as in claim 1, wherein the body further comprises a first body and a second body, and back surfaces of the first body and the second body are set with a plurality of connecting components.

6. The mixing light board as in claim 1, wherein the body is a circuit board, and one surface of the circuit board is set with a plurality of wiring conducting materials.

7. The mixing light board as in claim 1, wherein the body is made with general material.
